(19) United States
(12) Patent Application Publication
(10) Pub. No.: US 2004/0203982 A1
(43) Pub. Date: Oct. 14, 2004

(54) Controlling output power in cellular telephones

(76) Inventors: Ilan S. Barak, Kfar Saba (IL); Victor Korol, Petac-Tikva (IL)

Correspondence Address: Timothy N. Trop, TROP, PRUNER & HU, P.C., 8554 KATY FWY, STE 100, HOUSTON, TX, 77024-1841, US

(21) Appl. No.: 10/131,750

(22) Filed: Apr. 24, 2002

(51) Int. Cl. H04Q 7/20

(52) U.S. Cl. 455/522; 455/550.1

(57) ABSTRACT

A cellular telephone utilizing a variable power voltage control oscillator that may achieve a high dynamic range in output power is disclosed. In some embodiments, a microprocessor may be provided to adjust the amplitude of the variable power voltage control oscillator in response to transmitted commands that may be received.

### FIELD OF THE INVENTION

This invention relates generally to cellular telephones.

### BACKGROUND OF THE INVENTION

New cellular technologies, such as Wideband Code Division Multiple Access (“WCDMA”) promises to bring to users new capabilities such as packet-switched data such as high-speed Internet applications and electronic multimedia mail. WCDMA technology may also offer high-capacity circuit-switched capabilities for delivery of full-motion video services and high quality voice communications.

However, the WCDMA standard uses cellular telephones or other mobile transmitters to be manufactured having large dynamic ranges of a transmitted Radio Frequency (“RF”) power. For example, WCDMA standards may uses as much as a 70 dB range of transmit power. If the peak-to-minimum power fluctuations of the modulation, such as from a voice peak, are added to this number, a large dynamic range of greater than 90 dB may be needed.

To keep manufacturing cost low, WCDMA transmitters may be designed to integrate a considerable portion of the radio frequency circuits, and other circuits, within a few intergraded circuits. For example, a WCDMA transmitter may be designed with as many of the RF circuits, such as voltage control oscillators, integrated on a single integrated circuit that may be considered a transmitter function block.

However, the isolation between the input and the output of any transmitter function block may limit the dynamic range of that block by the amount of isolation that may be considered Pmin. In order to decrease power below Pmin, an effective increase in the isolation path must be achieved. An increase in isolation may typically be accomplished by physically distributing system components of the variable gain amplifier across a plurality of chips. This however may result in increased chip count and may increase manufacturing costs.

In cellular telephones, a signal source such as a voltage controlled oscillator (VCO) may be amplified by one or more variable gain stages. The minimum output power of the cellular telephone may therefore be limited for the reasons detailed above with the result that unwanted signal source power may be present in the cell phone RF output. Therefore, a need exists to improve the dynamic range of a transmitter such as WCDMA mobile transmitters.

### BRIEF DESCRIPTION OF THE DRAWINGS

FIG. 1 is a block diagram of a embodiment of a cell phone in accordance with the present invention.

FIG. 2 is a block diagram of a radio frequency section of a cell phone in accordance with a embodiment of the present invention.

FIG. 3 is a block diagram illustrating a variable power vco in accordance with a embodiment of the present invention.

FIG. 4 is a block diagram of a variable power voltage control oscillator in accordance with a embodiment of the present invention.

### DETAILED DESCRIPTION

In the following detailed description, numerous specific details are set forth in order to provide a thorough understanding of the invention. However it would be understood by those of ordinary skill in the art that the present invention might be practiced without these specific details. In other instances, well-known methods, procedures, components and circuits have not been described in details so as not to obscure the present invention.

It should be understood that the present invention might be used in a variety of applications. Although the present invention is not limited in this respect, the circuit disclosed herein maybe used in many apparatuses such as in the transmitters of a radio system. Radio systems intended to be included within the scope of the present invention include by way of example only, cellular radio telephone communications system, two way radio communications systems, one way pagers, two way pagers, personal communications systems (PCS), and the like.

Types of cellular radio telephone communication systems intended to be within the scope of the present invention include, although are not limited to, direct sequence- code division multiple access (DS-CDMA) cellular radio telephone communications systems, wideband CDMA and CDMA 2000 cellular radio telephone systems, global systems for mobile communications (GSM) cellular radio telephone systems, North American Digital Cellular (NADC) cellular radio telephone systems, time division multiple access (TDMA) systems, enhanced data for GSM evolution (EDGE), Universal Mobile Telecommunication Systems (UMTS) and WCDMA.

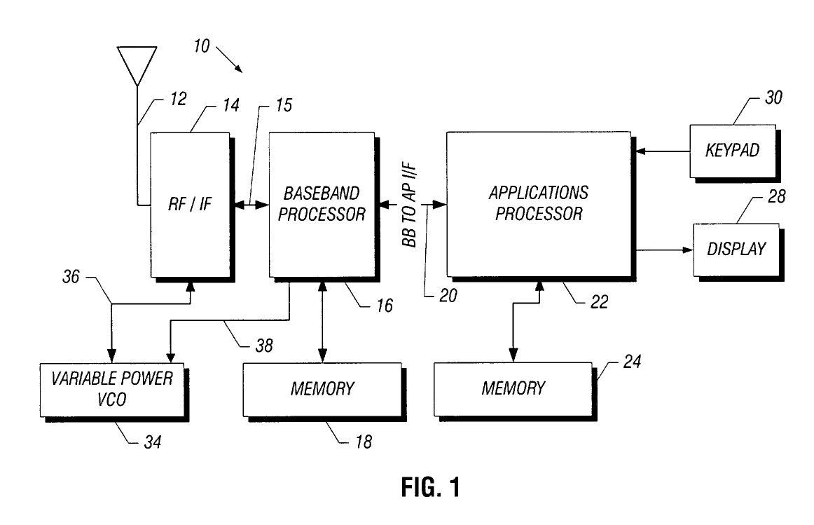

Referring now to FIG. 1, a cellular telephone 10 may include an antenna 12 coupled to a radio frequency interface 14. The cellular telephone 10 may be in accordance with any of the available communications standards. The interface 14 may communicate with a base band processor 16 over a bus 15. Likewise, the base band processor 16 may communicate with an applications processor 22 over an interface 20. The base band processor 16 maybe coupled to a memory 18 and the application processors 22 maybe coupled to a memory 24. In some embodiments, both the base band processor 16 and the applications processor 22 may be integrated into the same integrated circuit. In other embodiments, they may be on separate integrated circuits.

A display 28 and a keyboard 30 may be coupled to the applications processor 22. Additionally, in some embodiments, a base band processor 16 may also be coupled to a variable power voltage controlled oscillator (VPVCO) 34. The base band processor 16 may control the output power of the voltage controlled oscillator 34 through one or more control signals 38. VPVCO 34 maybe coupled to the radio frequency interface 14 through one or more signal lines 36.

As will be discussed in more detail subsequently, a base band processor 16 may control the output power of the VPVCO 34 and, in that manner, may effectively provide for an increased dynamic range in the output power of the cell phone 10.

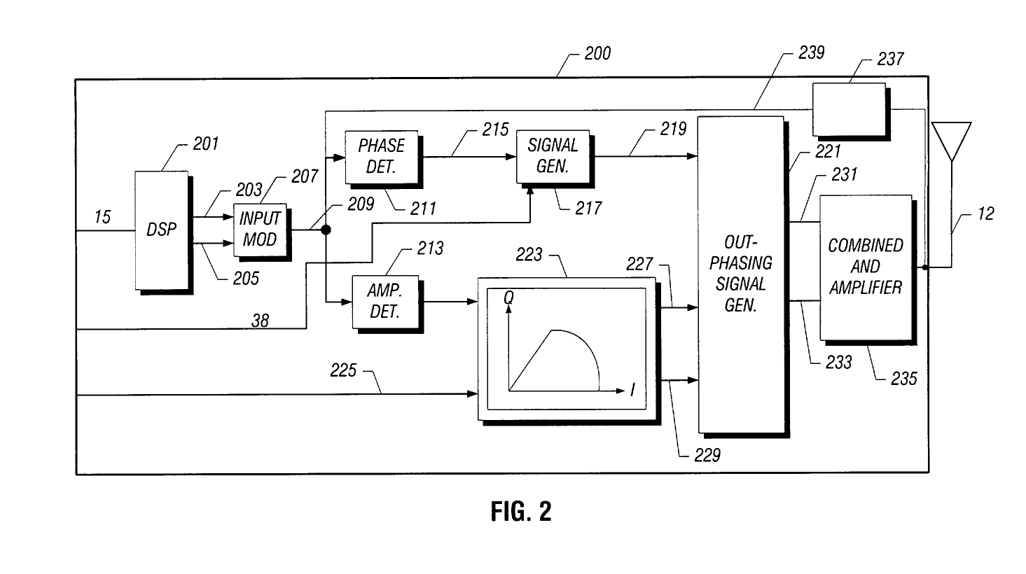

Referring now to FIG. 2, a portion 200 of the radio frequency interface 14 is illustrated. A digital signal processor (DSP) 201 may receive a signal over bus 15 and produce two constant envelope vectors I and Q, 203 and 205 respectively, which may provide inputs to a modulator 207. An output 209 from modulator 207 may provide inputs to a phase detector 211 and an amplitude detector 213. An output 215 from the phase detector 211 may be coupled to a signal generator 217. The signal generator 217 may include a loop filter and a VPVCO not illustrated. A variable power input 38 may also be coupled to a signal generator 217. Output 219 of the signal generator 217 may be coupled to an out phasing signal generator 221. Amplitude detector 213 may be coupled to a signal shaping circuit 223 that, in some embodiments, may be coupled to an input signal 225 that may comprise a GSM-EDGE signal. Outputs 227 and 229 of the signal shaping circuit 223 may provide additional inputs to the out phasing signal generator 221. Outputs 231 and 233 of the out phasing generator 221 may provide inputs to a combiner and a radio frequency power amplifier circuit 235.

Output 12 of the combiner and radio frequency amplifier 235 maybe coupled to an antenna and to a feedback circuit 237. An output 239 of the feedback circuit 237 may provide an additional input to the phase detector 211.

In some embodiments, feedback circuit 237 may include a step attenuator to step down the output power from the combiner and radio frequency amplifier 235 to a lower level. Additionally, feedback circuit 237 may include an RF mixer and phase splitter that may serve, in some embodiments, to mix down the frequency of the output of the combiner and RF amplifier 235 to a lower frequency and to adjust the phase of that signal prior to the input of phase detector 211.

Phase detector 211, in some embodiments, may generate a phase error signal that may represent the difference in the phase between the feedback signal 239 and the signal 209 from the input modulator 207. This error signal may then be utilized by the signal generator 217 to adjust a frequency of an internal VPVCO (not shown).

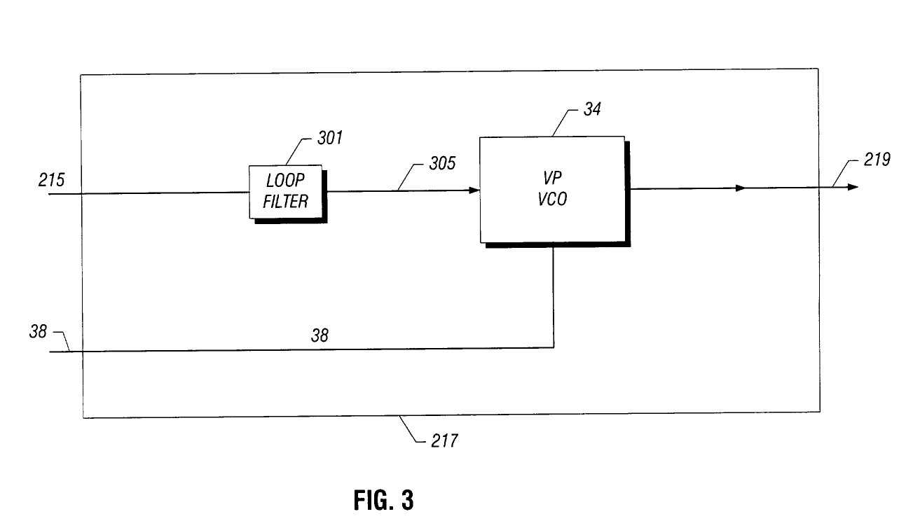

Referring now to FIG. 3, in some embodiments, signal generator 217 may include a loop filter 301 that maybe coupled to a VPVCO 303 by an error signal 305. Loop filter 301 in some embodiments, receives the output of phase detector 211 and filters the output of phase detector 211 to provide the error signal 305 to the variable power vco 303. The VPVCO 303 maybe designed such that changes in the signal 305 may cause the VPVCO 303 to change frequency in response to variations in error signal 305. Also, the output power of the VPVCO, in some embodiments, may change in response to changes in the variable power control signal 38.

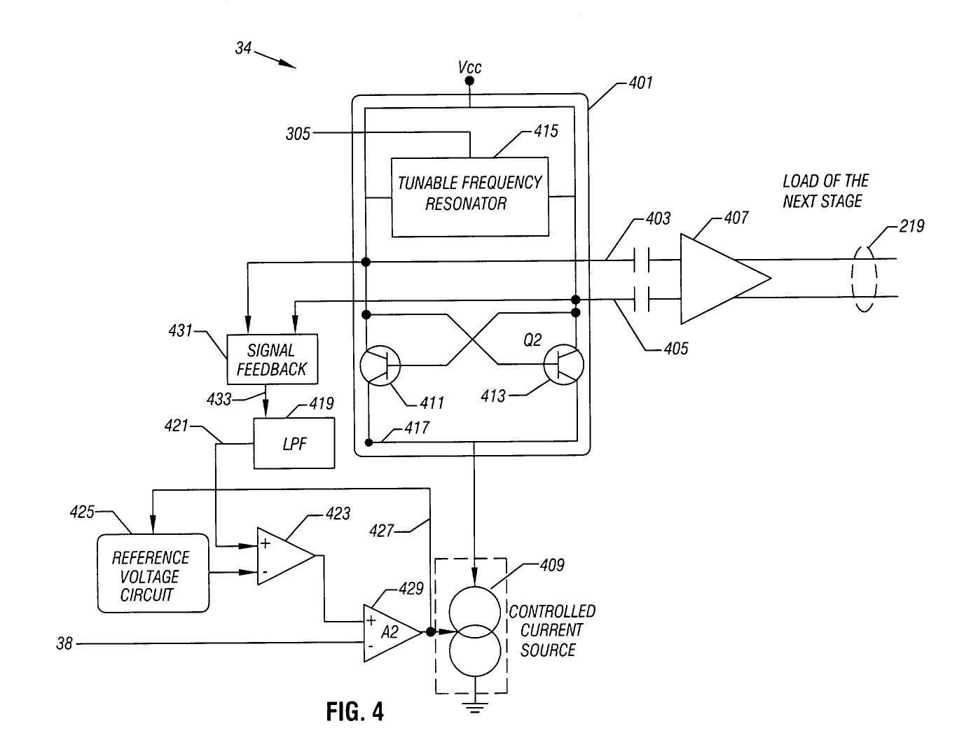

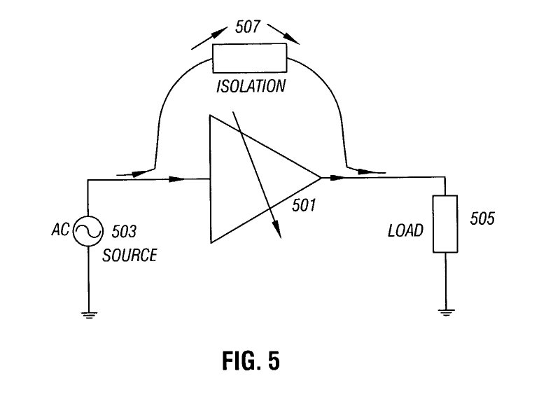

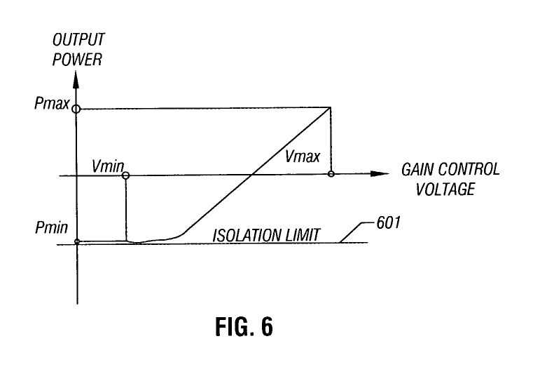

Referring now to FIG. 4, a differential VCO 401 may produce two output signals 403 and 405 that maybe of similar amplitude but phase shifted by 180 degrees from each other. These signals 403 and 405 may, in some embodiments, be buffered by buffer amplifier 407 that may be coupled through signal lines 219 to the out phasing signal generator 221 (shown in FIG. 2). To change the amplitude of the output signals 403 and 405, in some embodiments, the current provided by controlled current source 409 may be varied and thereby may change the current through transistors 411 and 413. The amplitude of the oscillation on signals 403 and 405 may be proportional to the dc current through transistors 411 and 413 since the dc current may define both the large and small signal transconductance of the transistors 411 and 413.

The variable frequency resonator 415 may be, in some embodiments, a voltage controlled oscillator. The voltage control oscillator 415 may be constructed as a Colpits, Hartley, or other oscillator type. The adjustment of the frequency of the VCO 415 may be accomplished by changing a voltage that may be applied to a voltage sensitive capacitor such as, in some embodiments, a varactor diode. As a voltage across a varactor diode varies, the net capacitance applied to an oscillator circuit, which incorporates the varactor diode, may also change thereby effecting a frequency shift. In some embodiments, error signal 305 may be coupled to a varactor diode, not illustrated, that may be part of the VCO 415 to effect a frequency shift of VCO 415.

To provide a feedback path for detecting the oscillation amplitude of the differential VCO 401, in some embodiments, output signal lines 403 and 405 may be coupled to a low pass filter 419 by a signal feedback circuit 431. The signal feedback circuit 431 may serve, in some embodiments, to combine the output signals 403 and 405, that may be differential signals, to provide an input 433 to the low pass filter 419. Signal 417 may include an alternating current (AC) signal and a direct current (DC) component that may be proportional to the amplitude of the oscillation of the differential VCO 401. Signal 417 may also include an offset voltage due to the current dependent voltage of the controlled current source 409.

The output 421 of the low pass filter may be coupled to one input of a differential amplifier 423. Another input to differential amplifier 423 may be provided by a reference voltage circuit 425 that may be coupled to an output 427 of a second difference amplifier 429. The output 427 of the differential amplifier 429 may also be coupled to the controlled current source 409 to provide adjustment of the controlled current provided by the controlled current source 409. An output from the differential amplifier 423 may be coupled to an input of differential amplifier 429. A second input to differential amplifier 429 maybe provided by signal 38 that may be coupled to base band processor 16 (shown in FIG. 1).

In some embodiments, the detection of the oscillation amplitude of the differential VCO 401 maybe achieved by filtering signal line 417. Signal line 417 may include an alternating current (AC) frequency signal, a direct current (DC) component that may be proportional to the amplitude of the oscillation of differential voltage control oscillator 401 and a voltage offset due to the current dependent voltage of the control current source 409. The detection of the amplitude may be achieved by filtering signal 417 with the low pass filter 419 and then subtracting a reference voltage 425 with a differential amplifier 423. The obtained signal, 431, may then be combined, in some embodiments, with the variable power control signal 38 with the differential amplifier 429 and then coupled to the current source 409.

The reference voltage circuit 425 may produce a voltage reference voltage that may be the current dependent voltage of the controlled source 409. In some embodiments, reference voltage circuit 425 may include a VCO that may be coupled to controlled current source (not illustrated). Manufacturing the reference voltage circuit 425 on the same integrated circuit and in close proximity to the differential VCO 401 may significantly reduce both process and temperature variation affects.

As discussed above, the output amplitude of the differential VCO 401 may be adjusted by adjusting signal 38. The base band processor 16, or other processor, to control, in part, the transmitter power in accordance with WCDMA or other standards, may adjust signal 38. The processor 16 or other processor may receive a power command from the cellular or other system commanding a reduction or an increase in transmitter output power. In response thereto, the processor 16 or other processor may effect a change in the VPVCO output amplitude and may change the gain in one or more RF amplifiers that receive, in part, the VPVCO output signal(s) or a signal or signals derived, in part, from the VPVCO output signal(s). In some embodiments, this reduction in the differential voltage controlled oscillator output may serve to effectively increase the dynamic range of the transmitting circuit, in part, by reducing the input signal to subsequent amplifier stages in a transmitter. This increase in dynamic range may be achieved utilizing a single integrated circuit that may contain the VPVCO and other coupled amplifiers although the scope of the present invention is not limited in this respect. The integration of the VPVCO and other coupled amplifiers onto a single integrated circuit may provide for manufacturing and other efficiencies.

While certain features of the invention have been illustrated and described herein, many modifications, substitutions, changes, and equivalence will now occur to those of ordinary skill in the art. It is, therefore, to be understood that the appended claims are intended to cover all such modifications and changes has fall within the true spirit of the invention.

What is claimed is:

1. A cellular telephone comprising:
a variable power voltage control oscillator (VPVCO) having an output; and
a first processor coupled to the VPVCO to adjust the power output of the VPVCO.

2. The cellular telephone as in claim 1 wherein the first processor is a base band processor.

3. The cellular telephone of claim 1 wherein the first processor is an applications processor.

4. The cellular telephone of claim 1 wherein the VPVCO includes a differential voltage controlled oscillator.

5. The cellular telephone of claim 4 further comprising a controlled current source coupled to the first processor to control the amplitude of the VPVCO.

6. The cellular telephone of claim 5 further comprising:
a reference voltage circuit coupled to the controlled current source and to the first processor to control, in part, the amplitude of the VPVCO.

7. The cellular telephone of claim 1 wherein the first processor is adapted to vary the amplitude of the VPVCO in accordance with a wideband code division multiple access cellular telephone standard.

8. The cellular telephone of claim 1 wherein the first processor is adapted to receive a power level command and is coupled to the VPVCO to adjust the amplitude of the VPVCO output in response to the command.

9. The cellular telephone of claim 1 further comprising:
a keypad coupled to the applications processor;
a display coupled to the applications processor;
a first memory coupled to the applications processor; and
a second memory coupled to a second processor.

10. An apparatus comprising:
a voltage controlled oscillator (VCO) having an output with an amplitude;
and
an attenuator coupled to the VCO to adjust the amplitude of the VCO output.

11. The apparatus of claim 10 wherein the VCO is a differential VCO.

12. The apparatus of claim 10 wherein the attenuator includes a controlled current source.

13. The apparatus of claim 12 wherein the controlled current source is coupled to a processor to control, in part, the controlled current source.

14. The apparatus of claim 13 wherein a voltage reference is coupled to the controlled current source.

15. The apparatus of claim 10 wherein the attenuator is coupled to a processor to control, in part, the amount of attenuation of the attenuator.

16. The apparatus of claim 15 wherein the processor receives a transmitted power command.

17. The apparatus of claim 10 further comprising a radio frequency amplifier coupled to the VCO output to transmit a signal.

18. The apparatus of claim 17 further comprising a processor coupled to the radio frequency amplifier to control, in part, the amplification of the radio frequency amplifier.

19. A method comprising:
generating a signal having a frequency and an amplitude utilizing a voltage controlled oscillator (VCO);
attenuating the signal amplitude in response to a second signal; and
transmitting a signal, derived in part, from the VCO signal.

20. The method of claim 19 including generating, in part, the second signal utilizing a processor.

21. The method of claim 20 further including generating the second signal in response to the processor receiving a transmitted command.

22. The method of claim 19 including attenuating the signal amplitude, in part, utilizing a controlled current source coupled to the VCO.

23. The method of claim 22 including attenuating the signal amplitude, in part, utilizing a voltage reference coupled to the controlled current source.

24. The method of claim 19 including generating the signal, in part, utilizing a differential VCO.

25. The method of claim 19 including utilizing a processor to control, in part, the amplitude of the transmitted signal.
